(19) United States
(12) Patent Application Publication
(10) Pub. No.: US 2017/0016642 A1
(43) Pub. Date: Jan. 19, 2017

(54) Systems for Calibrating Airflow Rates in Heating, Ventilating, and Air Conditioning (HVAC) Ducts and HVAC Systems Including the Same

(71) Applicant: Truveon Corp., Durham, NC (US)

(72) Inventor: Jan-Dieter Spalink, Durham, NC (US)

(21) Appl. No.: 15/208,887

(22) Filed: Jul. 13, 2016

Related U.S. Application Data
(60) Provisional application No. 62/191,698, filed on Jul. 13, 2015.

(51) Int. Cl. F24F 11/00; G06F 17/50; G01F 1/88

(52) U.S. Cl. CPC F24F 11/001; G01F 1/88; F24F 11/006; G06F 17/5004; F24F 2011/0063; F24F 2011/0075

(57) ABSTRACT

Airflow calibration systems are provided that are configured to be received in a duct of a heating, ventilating and air conditioning (HVAC) system. The air flow calibration systems include a housing including an air flow grid; and at least one pressure sensing cell positioned in the housing, the at least one cell being configured such that air flows through the at least one cell when the airflow calibration system is positioned in the duct of the HVAC system. The airflow calibration system is configured to be temporarily installed in the duct of the HVAC system to calibrate the HVAC system upon completion of the HVAC system or to recalibrate the HVAC system after a period of time.

### RELATED APPLICATIONS

The present application claims priority U.S. Provisional Application No. 62/191,698; (Attorney Docket No. 9484-5PR); filed Jul. 13, 2015, the disclosure of which is hereby incorporated herein by reference as if set forth in its entirety.

### FIELD

The present inventive concept relates generally to heating, ventilating and air conditioning (HVAC) systems and, more particularly, to measuring airflow rates in HVAC ducts.

### BACKGROUND

Heating, ventilating and air conditioning (HVAC) systems typically include a variety of different components to provide a complete heating and/or cooling cycle. These systems may include, for example, heat pumps, furnaces, compressors, fans, heat exchangers, one or more air ducts, air handlers and the like. These systems typically have a control device to receive control signals to operate the system to condition a space by heating or cooling the space to a desired temperature and humidity level. The control devices of the system are generally inter-connected to a thermostat that sends electronic signals to the various control devices based on a comparison between a desired temperature and/or humidity level for the conditioned space and the actual temperature and humidity of the space.

Efficient operation of these HVAC systems can be very difficult due to the multiple variables that effect operation thereof. For example, humidity, temperature, pressure, cleanliness and the like can all effect performance of the HVAC system. One metric in this context is the energy efficiency rating (EER) of an HVAC system, which typically requires on-going, accurate and reliable measurement of airflow through the HVAC system.

### SUMMARY

Some embodiments of the present inventive concept provide airflow calibration systems configured to be received in a duct of a heating, ventilating and air conditioning (HVAC) system, the air flow calibration systems including a housing including an air flow grid; and at least one pressure sensing cell positioned in the housing, the at least one cell being configured such that air flows through the at least one cell when the airflow calibration system is positioned in the duct of the HVAC system. The airflow calibration system is configured to be temporarily installed in the duct of the HVAC system to calibrate the HVAC system upon completion of the HVAC system or to recalibrate the HVAC system after a period of time.

In further embodiments, the HVAC system may include an air handler, a return manifold and a media cabinet between the air handler and the return manifold. The HVAC system may further include an entry transition manifold between the filter media cabinet and the air handler and an exit transition manifold between the air handler and a supply manifold. The at least one pressure sensing cell may include a plurality of pressure sensing cells installed at least in both the entry and exit transition manifolds.

In still further embodiments, the air flow grid may be positioned in the filter media cabinet.

In some embodiments, the HVAC system may include an air handler and a return manifold. The HVAC system may further include an entry transition manifold between the air handler and the return manifold and an exit transition manifold between the air handler and a supply manifold. The at least one pressure sensing cell may include a plurality of pressure sensing cells installed in at least both the entry and exit manifolds.

In further embodiments, the air flow grid may be positioned in a return air stream in front of the return manifold.

In still further embodiments, the air flow grid of the airflow calibration system may be coupled to an air handler module including a pressure difference unit and a data processing unit. The air flow grid may be configured to measure a first airflow value corresponding a first speed for a fan in the air handler, the first speed being selected by the air handler module. The original calibrated airflow value may be compared to the measured first airflow value to provide a deviation between the original calibrated airflow value and the measured first airflow value.

In some embodiments, the airflow grid may be configured to measure second through N airflow values and second through N deviations may be calculated for each of the corresponding airflow values.

In further embodiments, the airflow grid may be removed after the system is calibrated and replaced by a filter for normal operations.

In still further embodiments, the HVAC system may include a calibrated supply register configured to measure air flow in the HVAC system and determine a customized size for a supply register for the particular HVAC system.

In some embodiments, the HVAC system may further include at least one variable damper in a corresponding supply duct of the HVAC system configured to be controlled remotely to adjust airflow for each room associated with the at least one variable damper and the corresponding supply duct.

In further embodiments, the airflow calibration system may communicate with a local reference model that is updated by a shared reference module located in a central database. The central database may include information related to a plurality of HVAC systems remote from the HVAC system associated with the calibration system.

In still further embodiments, the system may be configured to measure an amount of air being conditioned for a specified unit of time.

Some embodiments of the present inventive concept provided heating, ventilating and air conditioning (HVAC) systems including an air flow calibration system. The airflow calibration system includes a housing including an air flow grid and at least one pressure sensing cell positioned in the housing. The at least one cell is configured such that air flows through the at least one cell when the airflow calibration system is positioned in the duct of the HVAC system. The airflow calibration system is configured to be temporarily installed in the duct of the HVAC system to calibrate the HVAC system upon completion of the HVAC system or to recalibrate the HVAC system after a period of time.

### BRIEF DESCRIPTION OF THE DRAWINGS

The accompanying drawings, which are included to provide a further understanding of the disclosure and are incorporated in and constitute a part of this application, illustrate certain non-limiting embodiment(s) of the inventive concept. In the drawings:

FIG. 1 is a block diagram illustrating a duct of a heating, ventilation and air conditioning (HVAC) system and an air flow measurement system in accordance with some embodiments of the present inventive concept.

FIG. 2 is a cross-section of an air flow measurement system including a plurality of cells in accordance with some embodiments of the present inventive concept.

FIGS. 3A and 3B are diagrams illustrating alternative cross sections of cells in accordance with some embodiments of the present inventive concept.

FIG. 4 is a block diagram of a system in accordance with some embodiments of the present inventive concept.

FIG. 5A is a block diagram of a data processing system for use in a building in accordance with some embodiments of the inventive concept.

FIG. 5B is a block diagram of a data processing system for use in a central reference model in accordance with some embodiments of the present inventive concept.

FIG. 6 is a block diagram of system including multiple buildings in accordance with some embodiments of the present inventive concept.

FIG. 7 is a block diagram illustrating a reference model in accordance with some embodiments of the present inventive concept.

FIG. 8 is a block diagram of an HVAC system in accordance with some embodiments of the present inventive concept.

FIG. 9 is a block diagram of an HVC system in accordance with some embodiments of the present inventive concept.

FIG. 10 is a block diagram illustrating an air handler module as illustrated in FIGS. 8 and 9 in accordance with some embodiments of the present inventive concept.

FIG. 11 is a block diagram of an HVAC system including a calibrated supply register in accordance with some embodiments of the present inventive concept.

### DETAILED DESCRIPTION

In the following detailed description, numerous specific details are set forth in order to provide a thorough understanding of the inventive concept. However, it will be understood by those skilled in the art that the present inventive concept may be practiced without these specific details. In other instances, well-known methods, procedures, components and circuits have not been described in detail so as not to obscure the present inventive concept.

As discussed in the background, efficient management and operation of Heating, Ventilating, and Air Conditioning (HVAC) systems can be very difficult due to the variety of variables that can affect the output. Embodiments of the present inventive concept are directed to systems for the determination of the actual heating and/or cooling capacity of an HVAC system, which requires measuring air flow rates in HVAC ducts using self-heated thermistors in the air stream. In particular, HVAC systems include ducts or pathways through which air flows to regulate the temperature of a closed space, for example, a house or office building, provide ventilation to the closed space and the like. These ducts can have various shapes and size, for example, ducts can be round or rectangular. The path of the duct may include various twists and turns, for example a 90 degree turn at a corner or a 45 degree change in direction. The variability of the path of the duct may make it difficult to regulate or control the air flow through the HVAC system in an efficient manner.

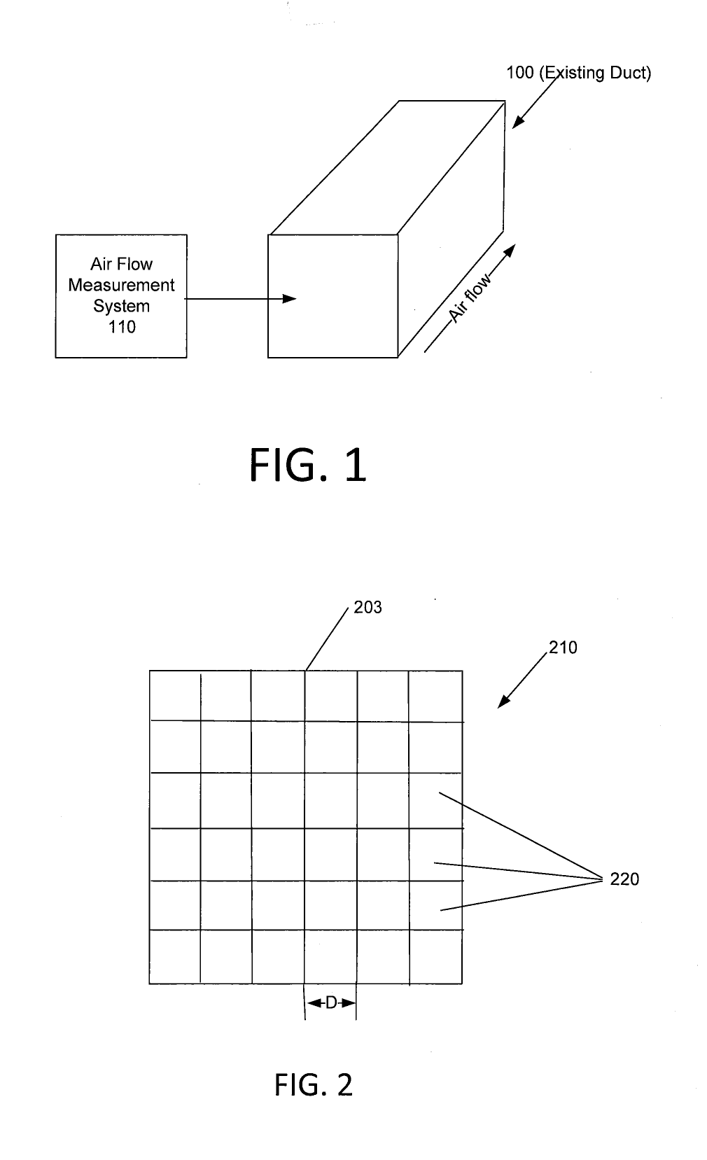

Accordingly, as illustrated in FIG. 1, some embodiments of the present inventive concept provide an air flow measurement system 110 that is configured to be installed in ducts 100 of an existing HVAC system. In other words, it is configured to fit within the confines of existing ducts 100, or be attached externally to these existing ducts for some amount of time. Thus, the air flow measurement system 110 can be attached, installed, uninstalled, replaced, repaired and the like without effecting the overall HVAC system. As will be discussed further herein, the air flow measurement system 110 in accordance with some embodiments collects “data” using various sensors, for example, self-heating thermistors, reference thermistors, humidity sensors, pressure sensors and the like. As used herein “data” refers to any data that can be sensed in an HVAC system that could be used to improve calibration or the ongoing operation of the HVAC system. For example, air temperature, temperature of nearby surfaces, relative humidity, air flow (circulation), radiant surface temperatures (walls, floors, ceilings, windows), air circulation patterns (supply and return register operation, damper positions), air exchange rate, ventilation rate, combustion byproducts (SO_{X}, NO_{X}, CO, CO₂, and the like), dust loads (PPM 2.5, PPM 10), air flow (draft) in open chimneys, room pressure differentials, air filter loads (air flow through filters) and the like. An amount of power supplied to the self-heated thermistor is regulated and this power value and the data collected from the various sensors are used to calibrate the HVAC system to achieve efficient operation thereof as will be discussed below with respect to FIGS. 1 through 11.

A thermistor is a passive electronic component whose electrical resistance varies with temperature, with a known relationship between resistance and temperature. In other words, the relationship between resistance and temperature is known for a given make and model of thermistor. The relationship can depend, for example, on the materials used, the size and shape of the resistive material, and presumably other factors known to the manufacturer of the thermistor. It will be understood that embodiments of the present inventive concept can be used with a wide range of thermistors from different manufacturers, and so the exact relationship is not known for all possible embodiments, but only in particular exemplary embodiments of the inventive concept. The manufacturer of the thermistor typically provides the relationship in the form of a table of values at each temperature. Typically, a user of embodiments of the present inventive concept would use the table of values to determine the relationship. There are also some equations which can be used instead, though they are approximations. For example, the Steinhart-Hart equation is often used for this purpose as discussed at World Wide Web address en.wikipedia.org/wiki/Thermistor.

When an electric current is passed through a thermistor, it creates a self-heating effect within the thermistor, which is a function of the amount of current and the resistance of the thermistor. This heat must be dissipated by the thermistor. In some embodiments discussed herein, the heat is dissipated into the air stream within the duct. The rate of dissipation increases when the air flow increases. Therefore, when the air flows slowly, heat dissipates slowly and the temperature of the self-heated thermistor rises. Similarly, when air flow increases, heat dissipation increases and the thermistor temperature falls.

As discussed above, in some embodiments of the present inventive concept, an amount of electrical power supplied to the self-heated thermistor is controlled. Thus, by driving the self-heated thermistor with a known amount of electrical power and obtaining a measured resistance, the temperature of the self-heated thermistor can be calculated using the known temperature-resistance relationship.

The temperature of the self-heated thermistor can be compared to a temperature read out by one or more non-heated reference thermistor(s) to determine the ambient temperature. The difference between the temperature of the self-heated thermistor and the temperature of the one or more reference thermistor(s) is the temperature rise due to self-heating. If the temperature rise and the amount of electrical power generating that rise are known, along with coefficients determined during the air low measurement system calibration, then the air flow rate can be calculated. The quantity being measured, roughly, is the rate of flow of mass (number of molecules). This is subtly different than the typical quantity considered in HVAC applications, which is volumetric flow rate, for example, cubic feet per minute. Mass flow rate is of more direct applicability, however, to calculations of HVAC system performance.

Referring now to FIG. 2, a cross section of the air flow measurement system 210 that is configured to be positioned in the duct of an existing HVAC system will be discussed. It will be understood that the air flow air flow across the heated thermistor can be substantially laminar (not turbulent) or turbulent. However, in some embodiments, in order to obtain accurate measurements using the air flow measurement system 210 in accordance with embodiments discussed herein, the air flow across the heated thermistor may be at least partially turbulent or completely turbulent (substantially turbulent). Turbulent air may result in better cooling of the heated thermistor. As illustrated in FIG. 2, embodiments of the present inventive concept include an array of “cells” 220 in a housing 203. Each of the cells 220 includes a pipe or tube of various cross-sectional shapes and dimensions. The cells 220 illustrated in FIG. 2 are square and form a grid-like pattern.

In some embodiments, the cells have a certain length in relation to the corresponding cross section of the cell. For example, the ratio of cell length to cross section may be from about 1 to more than 4. The cell has a certain relative length in relation to its cross-section so that a leading edge of the cell wall, which causes the turbulence, is sufficiently far upstream from the thermistor. Thus, in some embodiments, by the time the air reaches the thermistor location a sufficient amount of cooling may be achieved.

In some embodiments of the present inventive concept the sample locations are obtained in accordance with a spatial sampling system. As used herein, “a spatial sampling system” includes placing the thermistors (or other sampling devices) at specifically defined locations within the cell 220 (or duct). Thus, the locations where the air flow is being measured is well defined. The spacing of these locations or the distance therebetween is part of what creates a sampling effect. If the flow of air is not evenly distributed (inhomogeneous), then samples need to be obtained often enough so that any local changes can be detected and measured. In other words, in order to capture variations of the air flow (changes in flow in the space domain), the spatial sampling rate needs to be at least twice as high as the frequency of the spatial change. Similarly, the sampling rate needs to be at least twice as high as the flow changes over time.

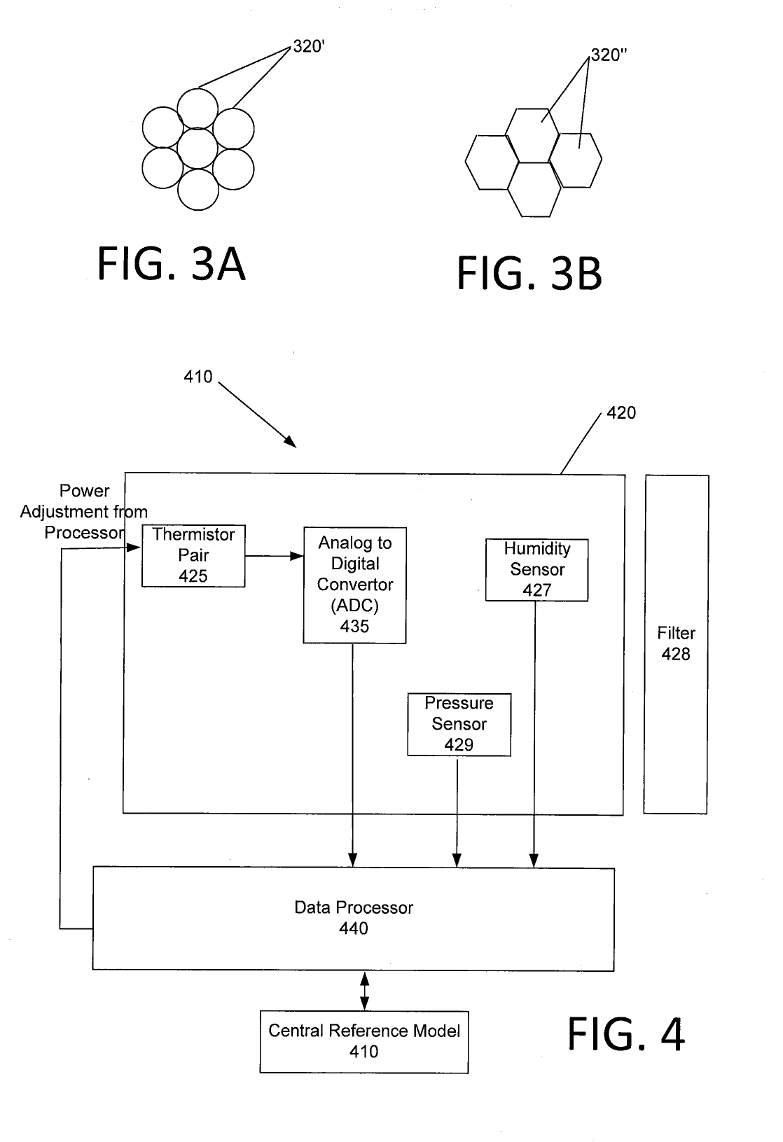

Although the cells in FIG. 2 are illustrated as being square in shape, embodiments of the present inventive concept are not limited to this configuration. For example, as illustrated in FIGS. 3A and 3B, the cells may also be, but are not limited to, circular 320′ and hexagonal (in a honeycomb layout) 320″. Only a portion of the cells 320′ and 320″ are illustrated in FIG. 3, however, it will be understood that when these cells 320′ and 320″ are included in a housing 203 of the air flow measurement system, they will fill the space similar to the cells 220 illustrated in FIG. 2. Some embodiments of the present inventive concept may involve the use of virtual cells that are not defined by any physical constraint of the air flow that may define a specific cross-section, such as circular or hexagonal, for example, but only by the physical location of the thermistor devices themselves within the cross-sectional space.

Referring again to FIG. 2, the dimensions of the cells may vary depending on the HVAC system in which they are installed. In some embodiments, for example, the cells may be about 4.0 inches in length L (going into the page of FIG. 2 in the direction of the air flow) and about 1.0 inch in cross-sectional diameter D, but will vary in different embodiments of the present inventive concept. As discussed above, as the air flows through the cells 220 partial or substantial (total) turbulence may be achieved at the site of the thermistor.

Referring now to FIG. 4, an airflow measurement system 410 including cells 420 in accordance with some embodiments of the present inventive concept will be discussed. As illustrated in FIG. 4, a cell 420 in accordance with some embodiments of the present inventive concept may include a thermistor pair, an analog to digital converter 435, a humidity sensor 427 and a pressure sensor 429. Although the cell 420 of FIG. 4 is illustrated as including all of these components, embodiments of the present inventive concept are not limited to this configuration. For example, the humidity and/or pressure sensor may be removed. Furthermore, as will be discussed below, not all cells 420 in the grid (FIG. 2, 210) may include a thermistor, which may reduce cost of the system.

As illustrated in FIG. 4, a cell 420 may include a “thermistor pair” 425, including both a self-heated thermistor and a reference thermistor. In some embodiments, the self-heated thermistor may be placed near the downstream end of the cell 420. The reference thermistor may be placed upstream of the heated thermistor, so that it is not affected by heat conducted from the heated thermistor. However, in some embodiments, one or more reference thermistors may be positioned next to the self-heated thermistor, but may be separated from it by a partition or vane, which blocks direct radiative transfer of heat to the reference thermistor(s).

In some embodiments, several thermistor pairs 425 are distributed over a cross-section of the duct, to measure air flow at multiple points. This is useful because air flow is not typically evenly distributed within the duct. By measuring at multiple points, a more accurate measurement of the total flow through the cross-section can be obtained as is understood by those having skill in the art based on Shannon's sampling theorem.

As discussed above, in some embodiments, not every cell 420 will include a thermistor pair. The flow within strategically chosen cells 420 can be measured, and from this measured data, the flow rate in the other cells that do not have a thermistor pairs 425 therein can be extrapolated. However, as discussed above, the housing/electronics of the air flow measurement system 410 can be removed and replaced “in the field.” Thus, it is possible in accordance with some embodiments to use a high-resolution version of the flow measurement system 410, in which every cell includes a thermistor pair 425 to perform a field calibration of the entire HVAC system as installed. After the HVAC system is calibrated, the high-resolution version of the system 410 may be removed and replaced with a system where less than all the cells 420 include thermistor pairs 425.

The high-resolution calibration may improve the accuracy of the extrapolation from measured cells to unmeasured cells, by characterizing the flow pattern in the duct system as installed with the high-resolution device. This field calibration can be repeated as often as desired, for example, during annual HVAC system maintenance. The high-resolution measurement can also be used to determine, for a given duct system as installed, what the ideal measurement location or locations within the duct cross-section are in order to provide the most accurate extrapolation to the entire duct cross-section. In other words, the calibration process may identify which cells 420 of the system 410 should include the thermistor pairs 425 to obtain the best measurements/results.

As further illustrated in FIG. 4, in some embodiments of the inventive concept, there may also be a humidity sensor 427 placed in one or more of the cells 420. Humidity measurement, in addition to being a useful measurement in HVAC applications, can also be used to improve the accuracy of the flow measurement by compensating for the effect of humidity on air density and thermal transfer from the heated thermistor to the air stream. As illustrated, some embodiments may also include an absolute (barometric) air pressure sensor 429 for the purposes of calculating air density, or some embodiments may use the altitude above sea level of the installation to approximate air pressure and density.

Over time, dust and debris carried by the air stream can be deposited on the thermistor, which may change the heat dissipation characteristics of the thermistors and, therefore, invalidate the calibration of the system. Thus, in some embodiments discussed herein, a filter 428 is positioned directly upstream of the flow measurement device 410. In some embodiments of the present inventive concept, a standard 4.0 inch (depth) pleated media filter may be positioned directly upstream of the flow measurement device to remove airborne particles. This filter 428 is also configured to be interchangeable, and can be cleaned or replaced at regular intervals as it accumulates dirt. The flow measurement system 410 can be used to determine, indirectly, when the filter 428 needs to be changed. The presence of the filter 428 may also provide a secondary benefit of evening out the spatial inhomogeneity to some extent possibly making the air flow more evenly distributed.

As discussed above with respect to FIG. 2, in some embodiments, the system 210 consists of a housing 203 with a rectangular (or square) cross-section. In some embodiments, the housing 203 may be about 8.0″ deep. In some embodiments, the housing 203 may be installed permanently into the duct system and the cells 220 may be interchangeable. The housing 203 may be configured to accommodate both the 4.0″ pleated media filter (428, FIG. 4) and a 4.0″ flow measurement device 210. The dimensions given here are the depth dimension; i.e., the dimension parallel to the direction of air flow.

It will be understood that these heights and widths are provided for exemplary purposes only. For example, the height and width may vary according to the requirements of the installation, for example, higher air flow volumes may require larger cross-sections. There also may be an increase in static pressure across the device. In other words, the more items placed into the air stream, per volume, the higher the static pressure drop becomes. It is generally not desirable to have a device a lot of static pressure drop inserted into a duct because it may lower the efficiency of the complete HVAC system. Although embodiments may be discussed herein with respect to the housing 203 being square or rectangular, embodiments of the present inventive concept are not limited to this configuration. For example, the housing may be circular without departing from the scope of the present inventive concept.

Embodiments of the present inventive concept go beyond the basic principle of operation of flow measurement using a self-heated thermistor compared to a reference thermistor. Embodiments of the present inventive concept offer various advantages, some of which will be discussed below.

Referring again to FIG. 4, aspects of the system 410 and cells 420 will now be discussed in detail. First, the electronics and signal conditioning in accordance with some embodiments of the present inventive concept will be discussed. The literature contains many references that discuss various methods of electrically driving thermistors to obtain the desired signal characteristics, which are generally known to those skilled in the art. Generally, these are analog circuits which attempt to obtain a linear signal; that is, an analog output which is nearly directly proportional to the amount of flow. Linear signals such as this may be desirable in analog systems, but thermistors are inherently non-linear in their response, and furthermore the relationship between air flow rate and heat dissipation is also non-linear.

Thus, in accordance with some embodiments of the present inventive concept, the complexity of attempting to achieve linearity in the analog domain may be avoided by doing the majority of the signal processing in the digital domain. The (non-linear) outputs of the thermistors are measured by an analog-to-digital convertor (ADC) 435, and a processor 440 is used to perform calculations related to air flow measurement and regulation.

Furthermore, much of the literature is concerned with the way in which power is delivered to the self-heated thermistor. Various approaches are possible: constant current, constant voltage, constant power, and constant temperature rise are typically discussed. Each of these approaches adjusts the current and/or voltage being delivered to the heated thermistor to maintain some quantity constant. This simplifies calibration, particularly in analog systems.

Systems in accordance with some embodiments discussed herein also put the software in control of driving the heating process for the thermistor. As illustrated in FIG. 4, the thermistor 425 receives a power adjustment signal from the processor 440. The processor 440 is configured to drive the thermistor with a variable amount of power input, so as to control the output of the thermistor relative to the ADC 435. In particular, most ADC's have a linear response, i.e. a single step in the digital output corresponds to a given change in input voltage, and the amount of change per digital step is the same throughout the entire voltage range.

In some embodiments of the present inventive concept, the input to the ADC 435 is non-linear, due to the fact that the relationship between temperature and resistance in the thermistor is non-linear, and also that the measurement circuit itself will typically have a non-linear characteristic. Thus, under some conditions of airflow, ambient temperature, and amount of power delivered to the heated thermistor, a given change in airflow will create a very small change in voltage, and under other conditions of temperature and pressure, it will create a larger change in voltage. A small change in voltage may be too small to be detected by the ADC 435, if it is beneath the resolution of the ADC 435, while a larger change would be detectable. So the effective resolution of the device, i.e. the smallest detectable change in airflow, changes based on different conditions of airflow, ambient temperature, and the amount of heating power delivered to the self-heated thermistor. By adjusting the heating power of the thermistor, the effective resolution of the device can be changed at a given airflow and ambient temperature, and embodiments of the present inventive concept do so in such a manner as to increase or possibly maximize the effective resolution under any given conditions of airflow and ambient temperature. In practice, this entails using more heating power when airflow is high and less heating power when airflow is low. This is a simplified example. The actual process is more precise than this and the details depend on the characteristics of the particular thermistor being used, the measurement circuit, and the ADC 435.

Thus, because the ADC 435 is measuring a non-linear signal received from the thermistor, the resolution of the system varies, depending on dynamic parameters of the system. But one of those dynamic parameters is the amount of power being delivered to the thermistor. Thus, by controlling this parameter with the processor 440, the overall resolution of the system with respect to air flow measurement can be increased or possibly maximized. In fact, it may be optimized in this manner for any particular air flow. The power being delivered to the thermistor is continually measured and adjusted by processor 440 to maintain this optimal performance.

Normally, a highly variable and dynamic control loop as discussed herein would pose a problem for the calibration of the air flow measurement system. Temperature rise in the heated thermistor is a function of both air flow rate and power delivered to the thermistor. If power delivered to the thermistor varies according to a complex and dynamic function running on the processor, a system calibration may not possible. Furthermore, because of the finite response time of the thermistor itself (due to its own thermal mass), whenever power input changes, sensor output will change only over time as the system comes into equilibrium. If power input is changing constantly, and also air flow is changing constantly, the system may never reach equilibrium. Therefore, a dynamic model in accordance with some embodiments is necessary.

In particular, the processor 440 is configured to continually measure three quantities: power input to the self-heated thermistor, resistance of the self-heated thermistor, and resistance of the reference thermistor. As discussed above, temperatures of the thermistors can be calculated based on the resistances thereof and temperature rise can be calculated from the obtained temperatures. The response time characteristics of the thermistor are determined during an initial calibration procedure and are assumed not to change during the life of the system. From all of these quantities, a dynamic (i.e., time-varying) model of the heat dissipation of the thermistor is calculated by the processor 440, and from that, the dynamic air flow is determined. The governing equation of the static equilibrium condition is:

Pₜ=k(Tᵣ−Tₐ), Equation (1)

where Pₜ is the total power dissipated by the thermistor (i.e., the rate of energy dispersed; the first derivative of energy with respect to time), k is the heat dissipation factor (units of power per degree; e.g., milliwatts per degree Kelvin), Tᵣ is the temperature of the heated thermistor, and Tₐ is the ambient air temperature (as measured by the reference thermistor). The heat dissipation factor (k) is itself a time-varying function of airflow and the static characteristics of the thermistor being used. This relationship between airflow and the heat dissipation factor (k) is characterized for each thermistor (or each make and model of thermistor) during initial system calibration.

Of the four quantities in this equation, the system measures three (Pₜ, Tᵣ, and Tₐ) and from those calculates the fourth (k), and then using the calibrated relationship between k and airflow can calculate airflow. However, to account for the time-varying nature of these quantities, in which power, ambient temperature, and airflow all change over time, a differential version of the above equation (differentiated with respect to time) must be employed, and the time constant of the system must be known. The time constant is primarily a function of the heat capacity of the heated thermistor, and can be measured during system calibration. By sampling the three measured quantities rapidly over time and employing a numerical approximation method of integration and differentiation, a time-varying measurement of airflow can be computed. These numerical methods and calculations may be carried out in real-time on the processor 440. Those skilled in the art will know of numerous possible numerical methods of integration and differentiation, any of which can be employed in embodiments of the present inventive concept without materially affecting the principle of operation.

Most systems are based on a “black box” model of an equilibrium relationship between sensor output and air flow rate. Systems in accordance with embodiments discussed herein are based on a dynamic, physical model of the system, where all measured quantities are considered as time-varying functions. The benefit gained from this is the ability to keep the system at a maximum resolution in all conditions: high flow, low flow, and varying ambient temperatures. This is possible because of the fully digital measurement and control loop, and the physical model (reference model).

Field calibrations and interchangeability in accordance with some embodiments of the present inventive concept will now be discussed. The physical design of systems in accordance with various embodiments of the present inventive concept may be of considerable practical importance. The rectangular cross-section of the housing 203 is familiar to HVAC tradesmen and is easily integrated into various duct systems, including retrofits into existing systems. The entire system 210, 410 may be only 8.0″ deep, allowing installation where limited space is available. Within 8.0″ of duct length, the system discussed herein filters, conditions, straightens, and measures the air flow. However, flow conditioning and straightening is never perfect, and the exact details of the duct system upstream and, to a lesser extent, downstream of the system will have an effect on the cross-sectional distribution of flow. Thus, embodiments of the present inventive concept are configured to take measurements at multiple points within the system.

As discussed above, there is a cost associated with each point of measurement. Therefore, to make the system economical, embodiments discussed herein allow the air flow measurement module to be interchangeable in the field, so that a high-resolution module (including thermistors/sensors in each cell 220, 420) can be slid into the housing, measurements made to characterize the flow with fine spatial resolution, and then the high-resolution module removed and replaced with a low-resolution module (less than all the cells include thermistors/sensors), which uses the high-resolution snapshot to extrapolate from one or a few measurement points to the entire cross-section. Because the basic shape of the duct system does not change much over time, the flow distribution also will not change much, and so the calibration should remain valid for quite some time. The calibration can be easily repeated during annual HVAC maintenance, or whenever (remotely) observed changes indicate that there has been a change in flow pattern. For example, if more than one point in the cross-section is being measured, the relationship of the flow rates at those points, relative to one another, should remain the same, so long as the duct characteristics have not substantially changed. Therefore, a change in the relative flows at the different points of measurement can be used to evaluate when a new high-resolution calibration of the system is desirable.

In embodiments in which more than one point of measurement is present, the inventive concept can take advantage of this redundancy in the event that one or more thermistor/sensor fails, but at least one thermistor/sensor continues to function. In these embodiments, it is still possible to extrapolate, using the high-resolution calibration or assumed flow distribution, even from one sensor to the entire cross-section, though in general with reduced accuracy.

In some embodiments, the low-resolution module may be field configured so that the installer, based on the results of the high-resolution calibration, places measurement units within only the most important cells for that particular duct configuration. The processor 440 may be configured to implement the cell selection. In particular, the processor 440 may be configured to automatically determine which cells are most relevant and provide the highest-quality extrapolation to the entire cross-section of the system.

In some embodiments, the data collected during high-resolution calibration may be transmitted to and stored in a central database which accumulates such data from many installations of the inventive concept. These observations can then be used to create and refine (“teach”) a central reference model which, among other things, can be used to determine, for a given duct system geometry and HVAC system configuration (fan type and power, nominal flow, and type of air filter, if any), the optimal or near-optimal placement of sensors within the duct cross-section, so that the need for a high-resolution calibration in every installation may be reduced. This can provide significant cost savings over a large number of installations, as high-resolution calibration would only be required in a fraction of the installations, to use for refinement and verification of the central reference model. Central reference models for use in HVAC systems are discussed in commonly assigned U.S. Pat. No. 7,839,275, the content of which is hereby incorporated herein by reference as if set forth in its entirety.

In some embodiments, the central reference model may be used to send a ready-made module to each installation with sensors already located in optimal locations as predicted by the model. Thus, field configuration of the sensor array may not be necessary.

Furthermore, systems designed in accordance with embodiments of the present inventive concept allow the flow modules to be easily replaced, to deal with long-term drift due to component wear and tear, or accumulation of dirt on the thermistors. In some embodiments, it may be possible to replace both the sensor cell array and the associated electronics (thermistor driving, signal conditioning, ADC, etc.), or replace only the sensor array, or only the electronics, in order to respond appropriately to different rates of drift in the different components.

Further properties/characteristics of the present inventive concept in accordance with various embodiments will now be discussed. Placement of the air flow measurement system 210, 410 behind a filter may allow measurement of the efficiency of the filter, as a function of the measured total air flow, as well as highs and lows in the flow distribution over the entire filter cross section. This has the advantage that filter efficiencies are dependent on the actual air flow, and not the total flow across the filter. The temporal and spatial characteristics of the air flow can be observed as a time series over the life of the filter, and in near real-time, if necessary. If a filter reaches critical levels of inefficiency in certain spots that would have a negative impact on the efficiency of the HVAC system, or on the resulting air quality (particle content of the air downstream of the filter), these can be detected in near real-time, and corrective actions (alarms, replacement requests) can be taken.

Air flow measurement systems in accordance with embodiments discussed herein have the ability to detect temporal and spatial variations on the air flow for the entire cross section. This allows detection of any temporal patterns at any and all individual locations over the entire cross section, or areas (subsets) of the cross section, and determines resulting total airflows over specific time periods by averaging over the sum total of observed patterns for that time frame.

Systems in accordance with embodiments discussed herein are also able to observe deviations between any and all cells of the device, calculate first derivatives, and derive evolving pattern changes fairly quickly; these could, for example, indicate that the filter that is located upstream of the device may have developed a defect, such as a hole or tear, or is filling up in a non-homogeneous way for different locations on the cross section of the filter.

Observed performance data for the device or for the filter can be used to derive performance reference models for the device or the filter. These reference models can be used to optimize the overall performance, such as the efficiency, or the air flow resistance, etc., of the device or the filter, or the combination of both.

If the device is located in an outside air intake, changes in the outside air quality can be detected, for example by comparing previous trends of particle accumulation on the air filter with actual observations and first derivatives thereof. The amount of outside air brought into the house for ventilation purposes can then be adjusted accordingly, or shut down completely if the dust or particle count in the incoming air exceeds a certain threshold.

Correlations between observed flows and the relative humidity of the incoming air, and the effect of the humidity on the efficiency of the filter can be taken into account. Temporary variations of the observed filter efficiency due to changes in the humidity of the filtered (incoming) air can therefore be separated from decreases in filter efficiency due to actual (permanent, on-going) particle accumulation.

In some embodiments, the measured air flow may be used in conjunction with a control system, including in some embodiments a model reference adaptive control system connected to a central reference model, in order to control aspects of the HVAC system such as variable-speed fan motors and motorized duct dampers, in order to deliver a desired amount of air flow through the system and/or to specific zones of the structure via motorized duct dampers. This could be used, for example, to facilitate explicit and optimized compliance with the ASHRAE 62.2 standard for building ventilation. This could also be used, for example, in a two-story building (multi-zone building) which contains only a single HVAC system, in order to balance the air flow to the upper and lower stories (various zones) according to different conditions, such as heating or cooling.

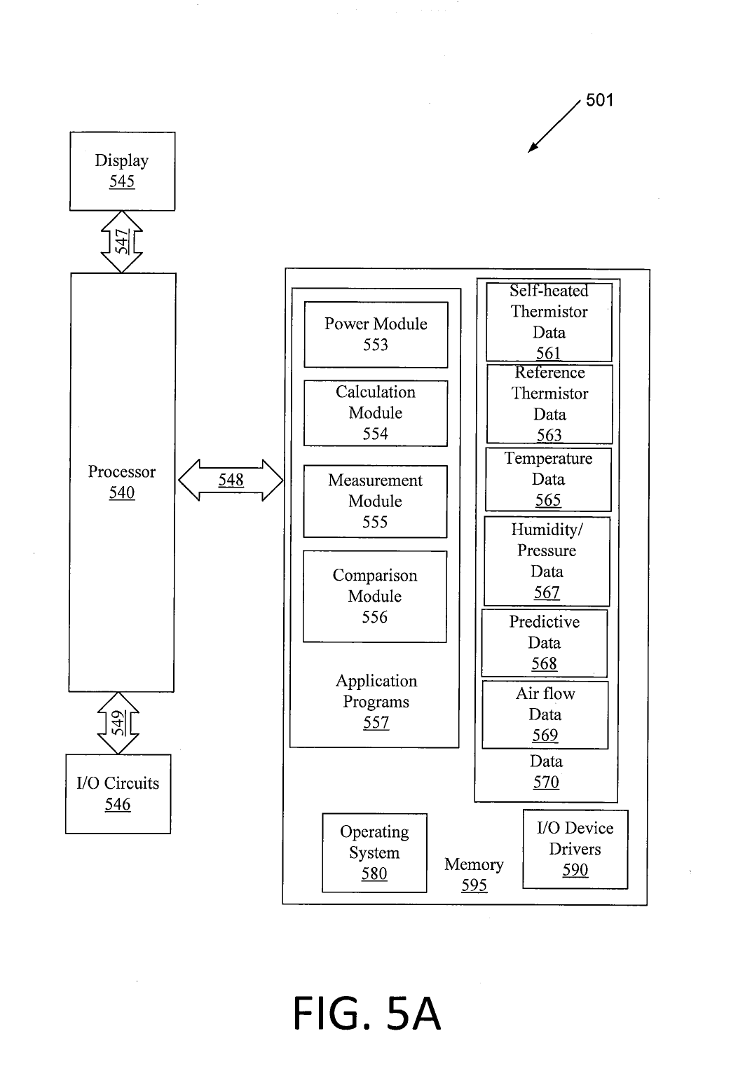

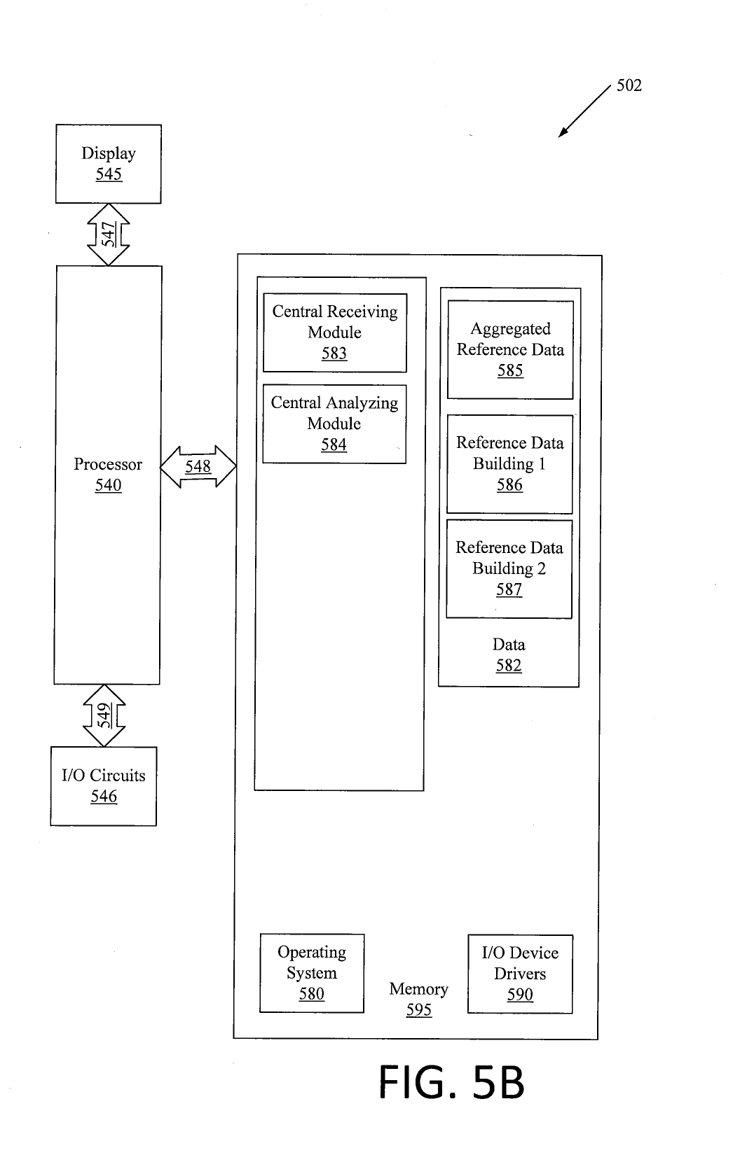

Details with respect to the data processor 440 will now be discussed with respect to FIG. 5A. As illustrated in FIG. 5A, an exemplary data processing system 501 that may be used to perform calculations, measurements and the like discussed above in accordance with some embodiments of the present inventive concept will be discussed. As illustrated, the data processing system 501 includes a display 545, a processor 540, a memory 595 and input/output circuits 546. The data processing system 501 may be incorporated in, for example, a personal computer, server, router or the like. The processor 540 communicates with the memory 595 via an address/data bus 548, communicates with the input/output circuits 546 via an address/data bus 549 and communicates with the display via a connection 547. The input/output circuits 546 can be used to transfer information between the memory 595 and another computer system or a network using, for example, an Internet Protocol (IP) connection. These components may be conventional components, such as those used in many conventional data processing systems, which may be configured to operate as described herein.

In particular, the processor 540 can be any commercially available or custom microprocessor, microcontroller, digital signal processor or the like. The memory 595 may include any memory devices containing the software and data used to implement the functionality circuits or modules used in accordance with embodiments of the present inventive concept. The memory 595 can include, but is not limited to, the following types of devices: cache, ROM, PROM, EPROM, EEPROM, flash memory, SRAM, DRAM and magnetic disk. In some embodiments of the present inventive concept, the memory 595 may be a content addressable memory (CAM).

As further illustrated in FIG. 5A, the memory 595 may include several categories of software and data used in the data processing system 540: an operating system 580; application programs 557; input/output device drivers 590; and data 570. As will be appreciated by those of skill in the art, the operating system 580 may be any operating system suitable for use with a data processing system, such as OS/2, AIX or zOS from International Business Machines Corporation, Armonk, N.Y., Windows95, Windows98, Windows2000 or WindowsXP from Microsoft Corporation, Redmond, Wash., Unix or Linux. The input/output device drivers 590 typically include software routines accessed through the operating system 580 by the application programs 557 to communicate with devices such as the input/output circuits 546 and certain memory 595 components. The application programs 557 are illustrative of the programs that implement the various features of the circuits and modules according to some embodiments of the present inventive concept. Finally, the data 570 represents the static and dynamic data used by the application programs 557, the operating system 580, the input/output device drivers 590, and other software programs that may reside in the memory 595. As illustrated in FIG. 5A, the data 570 may include, but is not limited to self-heated thermistor data 561, reference thermistor data 563, temperature data 565, humidity/pressure data 567, predictive data 568, and/or airflow data 569 for use by the circuits and modules of the application programs 557 according to some embodiments of the present inventive concept as discussed above.

As further illustrated in FIG. 5A, the application programs 557 include a power module 553, a calculation module 554, a measurement module 555 and a comparison module 556. While the present inventive concept is illustrated with reference to the power module 553, the calculation module 554, the measurement module 555 and the comparison module 556 being application programs in FIG. 5A, as will be appreciated by those of skill in the art, other configurations fall within the scope of the present inventive concept. For example, rather than being application programs 557, the power module 553, the calculation module 554, the measurement module 555 and the comparison module 556 may also be incorporated into the operating system 580 or other such logical division of the data processing system 501, such as dynamic linked library code. Furthermore, the power module 553, the calculation module 554, the measurement module 555 and the comparison module 556 are illustrated in a single data processing system, as will be appreciated by those of skill in the art, such functionality may be distributed across one or more data processing systems. Thus, the present inventive concept should not be construed as limited to the configuration illustrated in FIG. 5A, but may be provided by other arrangements and/or divisions of functions between data processing systems. For example, although FIG. 5A is illustrated as having multiple modules, the modules may be combined into three or less or more modules may be added without departing from the scope of the present inventive concept.

As discussed above, the data processing system 501 may be provided in a building, for example, a residence or office building in accordance with some embodiments of the present inventive concept. The date processing system 501 may be used in combination with the air flow measurement system 210, 410 in accordance with embodiments discussed herein, to regulate air flow in ducts of an HVAC system.

Referring now to FIG. 5B, an exemplary central data processing system 502 according to some embodiments of the present inventive concept will be discussed. It will be understood that like numbered elements of FIGS. 5A are substantially similar to like numbered elements of FIG. 5B and, therefore, the details with respect to these elements will not be discussed further herein. In particular, only the application programs 558 and the data 582 of FIG. 5B will be discussed in detail. As illustrated in FIG. 5B, the data 582 may include stored aggregated reference data 585, reference data associated with a first building 586 and reference data associated with a second building 587 for use by the circuits and modules of the application programs 558 according to some embodiments of the present inventive concept as discussed herein. It will be understood that, although only reference data associated with two buildings is illustrated, embodiments of the present inventive concept are not limited to this configuration. As discussed above, three or more buildings may be coupled to the central server and, in fact, the more buildings used, the more accurate the reference model.

It will be understood that deriving a common reference model for each particular type of home is of great practical value, so that deviations from the reference model (caused by irregularities in the construction process, for example, such as variations in the lengths or cross-sections of duct) can easily be detected during the commissioning process.

As further illustrated in FIG. 5B, the application programs 558 include a central receiving module 583 and a central analyzing module 589. While the present inventive concept is illustrated with reference to the central receiving module 583 and the central analyzing module 584 being application programs in FIG. 5B, as will be appreciated by those of skill in the art, other configurations fall within the scope of the present inventive concept. For example, rather than being application programs 558, the central receiving module 583 and the central analyzing module 584 may also be incorporated into the operating system 580 or other such logical division of the data processing system 502, such as dynamic linked library code. Furthermore, while the central receiving module 583 and the central analyzing module 584 are illustrated in a single data processing system, as will be appreciated by those of skill in the art, such functionality may be distributed across one or more data processing systems. Thus, the present inventive concept should not be construed as limited to the configuration illustrated in FIG. 5B, but may be provided by other arrangements and/or divisions of functions between data processing systems. For example, although FIG. 5B is illustrated as having multiple modules, the modules may be combined into one or more modules may be added without departing from the scope of the present inventive concept.

Referring to FIGS. 5A and 5B, the central receiving module 583 is configured to receive the data associated with the buildings and data associated with one or more other buildings. As discussed above, the more building from which data is collected, the more accurate the model and comparisons may be. The central analyzing module 584 may be configured to analyze the received data associated with the building and the one or more other buildings.

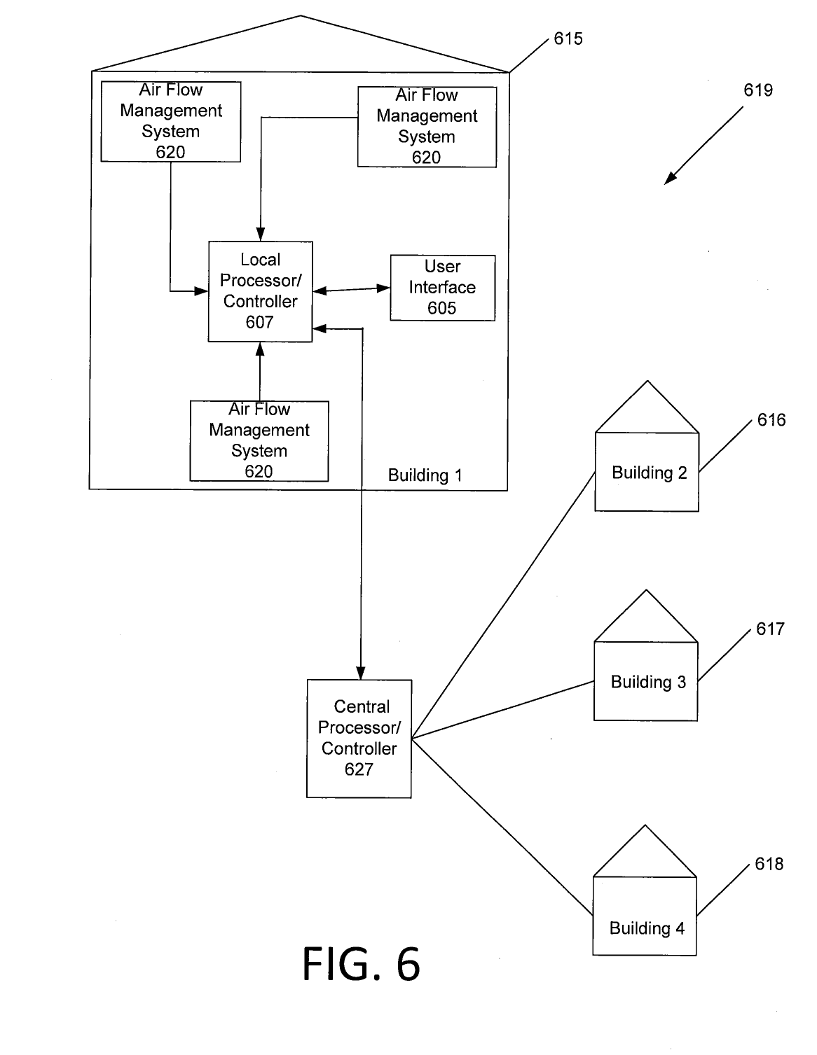

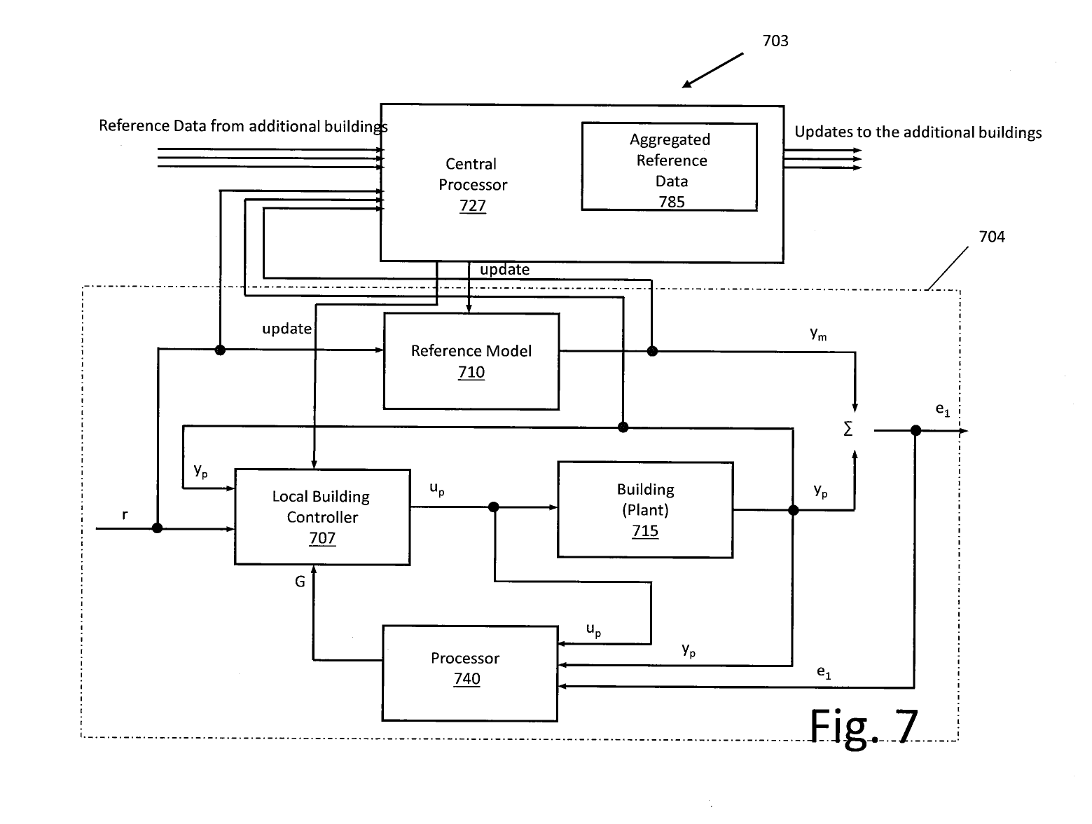

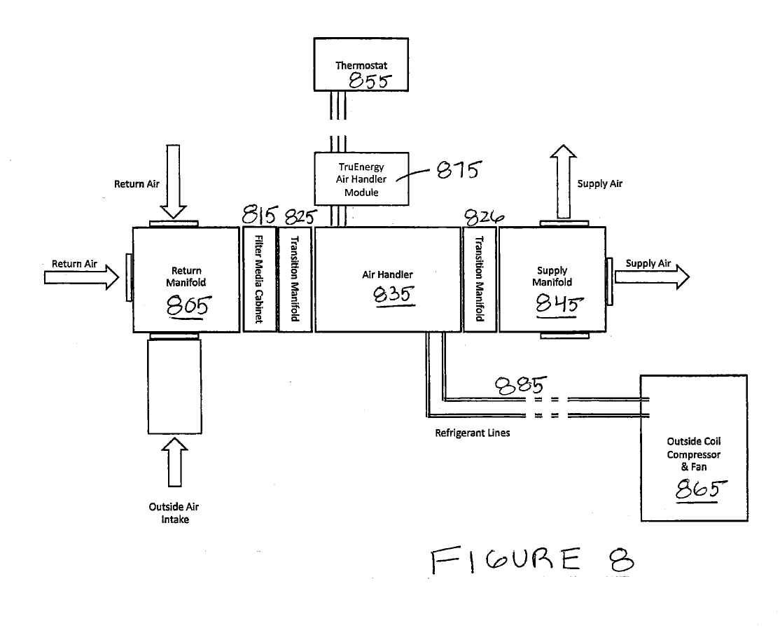

Referring now to FIG. 6, an HVAC system including local and central data processing systems according to some embodiments of the present inventive concept will be discussed. As illustrated in FIG. 2, an HVAC system 619 according to some embodiments of the present inventive concept may include first through fourth buildings 615, 616, 617 and 618, a central processor/controller 627, and a remote location 628. As further illustrated in FIG. 6, the first through fourth buildings 615, 616, 617 and 618 are coupled to the central processor/controller 627. The central processor/controller 627 may communicate with the first through fourth buildings 615, 616, 617 and 618 using, for example, a protocol that has been optimized, or adapted specifically for the purpose of this type of communication by incorporating, for example, explicit or implicit references, pointers or locators for processed reference data, performance metrics, time stamps, authentication codes, or anonymization process related variables.

As further illustrated in FIG. 6, the first building 615 (as well as the second through fourth buildings) includes one or more local processor/controllers 607, a user interface 605 and one or more air flow measurement systems 620 installed in the HVAC ducts in accordance with some embodiments of the present inventive concept. The user interface 605 and the air flow measurement systems 620 are coupled to the one or more local processor/controllers 607. It will be understood that although only a single user interface 6-5 and three systems 620 are illustrated in FIG. 6, embodiments of the present inventive concept are not limited to this configuration. For example, two or more user interfaces 607 and many systems 620 may be provided without departing from the scope of the present inventive concept.

The local processor/controller 607 may include the modules and operate as discussed above with respect to FIG. 5A. Similarly, the central processor/controller 627 may include the modules and operate as discussed above with respect to FIG. 5B.

Referring now to FIG. 7, a block diagram illustrating an exemplary climate control system according to some embodiments of the present inventive concept will be discussed. As illustrated in FIG. 7, the HVAC system 703 includes a local data processor 704 and a central processor 727. Furthermore, the local data processor includes a reference model 710, a local building controller 707, a building (plant) 715 and a processor 740. As further illustrated, the central processor 727 includes the aggregated reference data 785, which may include data collected by the thermistors, humidity sensors, pressure sensors and the like in accordance with various embodiments discussed herein.

First, the local data processing system 704 and the elements thereof will be discussed. In particular, the local building controller 707 receives r and yₚ, where r is the input command vector, which represents the planned intended state (performance metrics and/or specifications of the plant), and where yₚ is the actual plant output vector, represented by the actual sensed data, i.e., actual state of the building. These two inputs vectors are compared and if they are not the same, one or more parameters of the controller 707 are adjusted and the control output vector uₚ is modified accordingly. Thus, the controller 707 generates input parameters for the plant 715, such as, close the damper, turn on the heat, turn on the AC and the like. Since, the building (plant) 715 is not linear or time invariant, it experiences state changes due to windows opening, weather changes, humidity changes and the like. The output vector of the building (plant) 715 represents the actual plant state yₚ, which is compared to the output of the reference model 710. If the sum eₗ (a tracking error vector) of yₚ and yₘ is not zero, then the processor 740 adjusts a gain vector G until the sum of yₚ and yₘ is zero. Thus, the local data processing system 704 is capable of adjusting various parameters to regulate the air flow in the ducts of the HVAC system. Details with respect to the model reference adaptive control approach as discussed with respect to FIG. 7 are discussed in Robust Adaptive Control to P. A. Ioannou et al. (Prentice Hall, 1996, p. 314), the disclosure of which is hereby incorporated herein by reference as if set forth in its entirety.

As further illustrated in FIG. 7, the reference model 710 and the building controller 707 are updated by the central processor 727. The reference model according to some embodiments of the present inventive concept is unique due to the derivation and the ongoing modification of the reference model 710 based on data collected from different buildings. For example, when embodiments of the present inventive concept are used in conjunction with a newly constructed building, the initial parameters for a reference model that is unique for that particular building may be derived from initial specifications collected during the planning phase of the building and from aggregated reference data 785 collected previously from other buildings coupled to the central sever. Once the initial reference model 710 is constructed, it will be adapted and modified for the specific circumstances and operating conditions of this particular newly constructed building according to some embodiments of the present inventive concept.

In addition to measuring airflow rates, efficient management of Heating, Ventilating, and Air Conditioning (HVAC) systems further involves an energy efficiency rating (EER). EER is a key metric that is used as a reference in order to achieve and maintain efficient HVAC system operation. EER requires air flow measurement, i.e. without air flow measurement, no EER can be calculated. Conventional air flow measurement devices typically require specific duct configurations in order to deliver a reliable measurement. Currently, there is no known system on the market that can be installed in a random return duct configuration and still deliver an accurate air flow measurement. Embodiments of the present inventive concept address this problem by providing systems and methods for calibrating the measurement system after it has been installed.

In particular, as will be discussed below with respect to the Figs., embodiments of the present inventive concept provide a high resolution (spatial and temporal) air flow measurement device that can relatively easily be installed and removed (filter cabinet) and use this device to calibrate a permanently installed device that integrates spatial and temporal variations and, thus provides reliable and accurate air flow measurements.

The calibration data can be stored locally or in a central repository where these calibration data are safe from reverse engineering without departing from the scope of the present inventive concept. Embodiments of the present inventive concept may provide various operational benefits, such as quality control for work provided by technicians on site; maintenance of high quality performance; capture of manometer data and refrigerant temperatures concurrently at the time of installation or commissioning; correlation; ability to check system performance without the need for a manometer; and the ability to perform most maintenance activities with needing to enter the home using, for example, remote t-stat override of the TruEnergy system. However, it will be understood that embodiments of the present inventive concept are not limited to these advantages.

Referring now to FIG. 8, a block diagram illustrating an HVAC system 800 in accordance with some embodiments of the present inventive concept will be discussed. As illustrated in FIG. 8, the system 800 includes a return manifold 805, a filter media cabinet 815, transition manifolds 825, an air handler 835, a supply manifold 845 a thermostat 855, an outside coil compressor and fan 865 and an air handler module 875 in accordance with some embodiments of the present inventive concept. As further illustrated in FIG. 8, the return manifold receives both return air and outside air; the supply manifold 845 supplies air and the air handler 835 is coupled to the outside coil compressor and fan 865 by refrigerant lines 885. It will be understood that embodiments of the present inventive concept are not limited by the configuration provided in FIG. 8.

In some embodiments, an airflow measurement system (“air flow grid”) 200 (FIG. 2) configured to be installed in an HVAC system similar to the HVAC system of FIG. 8 includes a housing 210 for a calibrated sensing device and at least one cell 220 positioned in the housing. The at least one cell 220 is configured to measure an amount of air flowing through the cell per unit time, for example, cubic feet per minute (cfm). The at least one cell 220 may have been previously calibrated to provide a continuous or time discrete reading of the actual flow of air through the cell at any particular point in time.

Embodiments of the present inventive concept use an air flow grid as discussed above during the initial commissioning of an HVAC system (800) for the purpose of calibrating a permanently installed system to measure a pressure differential that exists when air flows through the air handler 835. This pressure differential is a function of the volume of air flowing through the air handler 835, and also of the particular mechanical characteristics of each air handler 835. The mechanical characteristics may include, for example, capacity and efficiency of the installed fan and motor driving the fan (865) that is moving the air through the air handler 835. Furthermore, air flow resistance of the entire air path through the mechanical assembly of the air handler 835 is subject to variations that are an inevitable result of the manufacturing process, the choice of specific types of fans, types of fan blades, and fan motors, their internal housing and air ducting characteristics, and associated (and unknown) variations in the tolerance of each component thereof that are unavoidable in any kind of volume manufacturing process. Size, type, material, position and geometry of the expansion coil 865, for example, roof, inverted roof, flat and slanted coil, and the like may affect the pressure differential. An operational state of the expansion coil, which is also part of the air handler assembly 835, such as the temperature of the coil, and whether it is completely or partially dry or wet, and more or less water on certain areas of the coil will have a distinct and non-linear effect on the air flow resistance of the coil itself. The amount of water condensing on the coil during normal operation of the HVAC system is a function of the relative humidity of the air moving through the air handler 835, and of the temperature of certain areas of the coil. The amount of water on the coil is therefore a function of the particular point in time within a cooling cycle, i.e., whether the time in question is at the beginning of such a cooling cycle, somewhere in the middle, or towards the end of the cooling cycle, for example.

Some embodiments of the inventive concept relate to the process of deriving the actual air flow through an air handler 835 from the pressure differential across the air handler, or between various parts of the pathway of the air through this air handler. A key element of the inventive concept is the position of the one or more sensors, for example, a pressure sensor that is used to measure the pressure differential discussed above. In particular, it can be demonstrated that the return 805 and supply duct 845 manifolds attached to the air handler 835, both at the entry and at the exit of the air handler 835 as illustrated in FIG. 8, the sizes and the locations of attached distribution ducts attached to the duct manifolds, and their relative geometry, as well as the position of the one or more sensors, all have a distinct impact on the overall pressure differential that can be observed for a particular flow of air through the air handler.

In some embodiments, a pressure difference between the return duct manifold 805 and the ambient pressure at the site of the air handler 835 and a pressure difference between the supply duct manifold 845 and the ambient pressure at the site of the air handler 835 may be obtained. These two pressure differences may be combined to yield a pressure difference across the air handler cabinet. Embodiments of the present inventive concept calibrate the whole assembly (air handler plus all the ducts already attached) in situ, after all of the installation processes for the air handler and the attached ducts have taken place. Furthermore, embodiments of the present inventive concept are vendor independent, i.e., viable across virtually all of the different air handlers currently on the market, as sold by various system manufacturers.

For a given set of one or more sensor positions at the entry and the exit of the air handler 835, or anywhere along the path of the air flowing through the air handler, i.e., their distance from the air handler entry and exit, or from the edges of the return or supply manifold assembly, for example, pressure differentials can be correlated directly with the air flow that can be determined with the use of an air flow grid (see FIG. 2). Thus, a filter media housing 815 for such an air flow grid is installed between the return duct manifold 805 and the air handler 835 as illustrated in FIG. 8.

Thus, the actually observed pressure differential across the air handler 835 for a given volume of air flowing through the air handler can be directly (in vivo, and in-situ) correlated with the actual air flow, as measured with the air flow grid at any point in time. Once this correlation has taken place, the air flow grid can be removed from the assembly, and a regular air filter can be inserted instead into the filter media housing 815 for the air flow grid. If there is any doubt at a future point in time about the accuracy of the air flow data derived from the observed pressure differentials, then the air filter can be removed from the housing, and a calibrated air flow grid can be inserted again in order to repeat the calibration of the permanently installed one or more sensors.

Furthermore, in accordance with embodiments discussed herein, an expensive, high precision air flow grid can be used for the calibration or re-calibration of the permanently installed one or more sensors. This high precision air flow grid can then be used for any number of additional air handler installations and, thus, facilitate an even, and much more economical measurement of air flows through any number of installed air handlers 835.

A high precision air flow grid can be used to detect uneven spatial and temporal distributions of air flow within the manifold, and a corresponding (proprietary) positioning of the one or more sensors, as well as respective processing algorithms for observed pressure differentials can be effected.

Furthermore, weights can be assigned to the one or more sensors, with their relative weights being a function of their physical positioning on the transition manifold, to capture the spatial or temporal inhomogeneity of the air flow through the manifold, as observed by the air flow grid. The air flow grid may be used to detect uneven air flow distributions (temporal and spatial), and then indicate the appropriate locations for the one or more sensors, plus time spans for each pressure measurement that are needed in order to compensate for temporal air flow variations.

Operations for system calibration in accordance with some embodiments of the present inventive concept will be discussed. In particular, during the initial commissioning of an HVAC system, which is an essential part of the installation process of such a system in a home, the following steps are envisioned:

The air handler has a four inch filter media cabinet 815 installed between the return manifold 805 (which terminates all of the return ducts) and the air handler 835 as illustrated in FIG. 8.

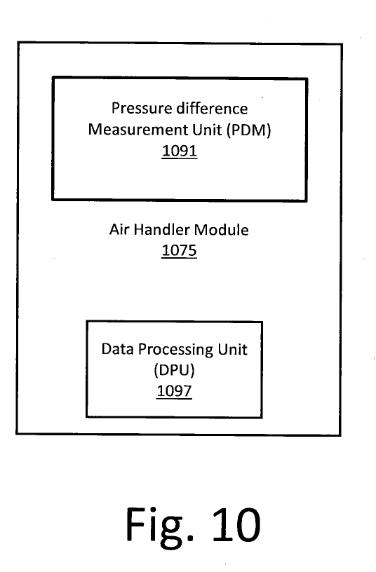

A transition manifold 825 (entry transition manifold) is installed between the filter media cabinet 815 and the air handler intake 835, designed such that it adapts the different geometries (depth and height) of the filter cabinet 815 and the air handler intake 835. However, in some embodiments, a transition manifold may be omitted and the pressure sensors may be directly installed in the return duct manifold and the supply duct manifold. Embodiments of the present inventive concept are not limited to either configuration.
transition manifold 826 (exit transition manifold) is installed between the exit of the air handler 835 and the entry of the supply side manifold 845 that terminates all the supply ducts.
One or more pressure sensing devices are installed in the entry transition manifold 825, and also in the exit transition manifold 826 (not shown).
Once the entire HVAC system has been installed, and is fully operational, an air flow grid is inserted into the filter media cabinet 825.
The air handler module (AHM) 875, 1075 (FIG. 10) of the installed TruEnergy system selects one specific speed (S1) for the fan in the air handler 835, which results in the flow of a particular amount of air per time unit through the air handler assembly and the attached duct system in the house.
The air flow grid installed in the filter media cabinet 825 measures the resulting air flow (AF1) that corresponds to the selected air handler fan speed S1.
The pressure difference measurement unit (PDM) 1091 (FIG. 10) of the AHM detects a pressure difference (PD1) that corresponds to the air flow AF1.
The data processing unit (DPU) 1097 of the AHM records the value of PD1, and associates it with the AF1, as determined by the air flow grid.
The air flow grid has previously been calibrated against a known air flow standard. Thus, for each of the individual cells of the air flow grid, the accuracy for each cell is known, i.e., a known deviation exists between the actual air flow through the cell, and the air flow AF1 as measured by the cell.
Air flows through a return manifold and any kind of return transition manifold are not distributed homogeneously in space, due to the particular geometries (specific locations on the manifold, angles of entry, etc.) involved in attaching return ducts to the return manifold, or in time, due to turbulences of the air inside those return ducts.
The air flow grid has cells distributed over the entire cross section of the return manifold. The number of cells per linear distance of the air flow grid, in both the vertical and horizontal dimension, determines the spatial resolution of the air flow measurement in areas of different air flows through the manifold, according to Shannon's sampling theorem.
Each cell has the ability to detect changes in the flow of air, according to Shannon's sampling theorem, as a function of the time interval it uses to measure air flow in that cell. The length of this time interval therefore determines the ability to detect changes in air flow over time.
The position of the one or more pressure sensing devices in the transition manifolds, both for the entry transition manifold, and for the exit transition manifold, and the method of processing observed pressure data by the DPU 1097 determines the accuracy of the observed pressure differential by the DPU 1097.
The process of correlating a known value of air flow, as determined by the air flow grid, with an observed pressure difference, as determined by the DPU 1097 is now repeated for as many different air flows AFn that the fan of the air handler is able to generate. In addition, various settings of a zone controller can also be deployed, since they might change the amount and the geometric distribution of air in the return ducts, and thus result in changed air flow distribution inside the return manifold. The data processing unit (DPU) 1097 (FIG. 10) of the AHM then records the values of PDn, and associates it with the AFn, as provided by the air flow grid, for each of the observed modes of operation of the HVAC system.
Once this process of calibrating the PDM 1091 has been completed, the air flow grid is then removed from the filter media cabinet, and is replaced by a four inch media filter for the normal operations of the air handler.
The PDM 1091 is now able to determine reduced air flows through the air handler, as the filter absorbs more and more dust and other materials over time.
The PDM 1091 is also able to observe if the air handler fan is providing nominal air flows for each mode of operation of the HVAC system, such as “fan only”, “cooling”, “heating”, or “auxiliary heat”, for example. The PDM 1091 can detect any deviations, and provide actual air flow data to the AHM for the TruEnergy system, where they can be used to calculate the real-time EER of the HVAC system, for example, or use the AFn data for other diagnostic purposes.
If at any point in time, irregularities are observed in the function of the air handler, which might be caused by changes in the physical properties of the air handler cabinet itself, or any of its mechanical components, or by a change in the functionality of a zone controller or a fresh air intake, for example, the filter can be removed from the filter media cabinet, and a calibrated air flow grid can again be inserted instead of the filter. The entire calibration process, as described above, can then be repeated, if desired, and the calibration data stored in the PDM 1091 or the AHM or anywhere else in the TruEnergy system, can be updated.
During normal operation, the PDM 1091 does not have to store and transmit actual PDn data to the AHM, but rather use raw sensor data instead. The translation of raw sensor data into actual PDn, or AFn, for that matter, can be performed by a program that is located at the central supervisory unit of the TruEnergy system. This kind of functional distribution would provide a very useful protection against any attempt to reverse engineer the functionality of the TruEnergy system because it would not allow any third party to directly correlate any observed AFn with a PDn.

Although processes for calibrating a system in accordance with some embodiments of the present inventive concept were discussed above with respect to FIG. 8, it will be understood that embodiments of the present inventive concept are not limited to this configuration.

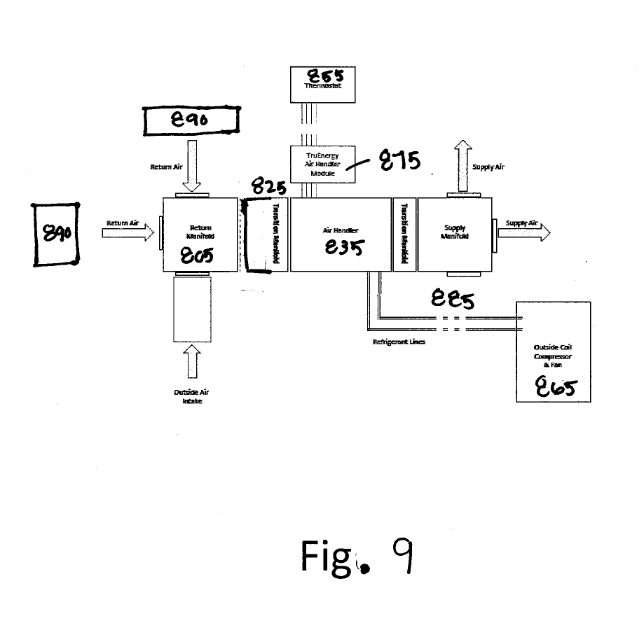

Referring now to FIG. 9, a block diagram of an HVAC system in accordance with some embodiments of the present inventive concept will be discussed. The system of FIG. 9 is very similar to the system illustrated in FIG. 8, thus, like referenced numerals refer to like elements therein. However, the system of FIG. 9 does not include the filter media cabinet 815 of FIG. 8 and includes an airflow grid in the return air stream. This may be accomplished in many ways according to embodiments of the present inventive concept, which will be discussed further herein.

As illustrated in FIG. 9, the filter cabinet is removed and an air flow grid 890 is temporarily inserted into the return air stream in front of the return register, i.e., where the air that is returning from the house is entering the duct system. In some embodiments, a piece of duct (“airflow manifold”) may be positioned temporarily directly in front of the return register that has an air flow grid as one of its integrated components. This airflow manifold may be shaped such that the opening for the return register at least matches (or exceeds) the physical dimensions of the return register, such that the active opening or face of the return register is substantially (completely) covered by the airflow manifold. The airflow manifold may also include a gasket installed at the opening that covers the return register, in order to make sure that it achieves an airtight seal.

Embodiments of the present inventive concept illustrated in FIG. 9 may not require the installation of a filter cabinet as shown and may not require the manufacture of various sizes of the airflow grid. One size of the air flow grid may fit all applications, as long the airflow manifold fits all return registers.

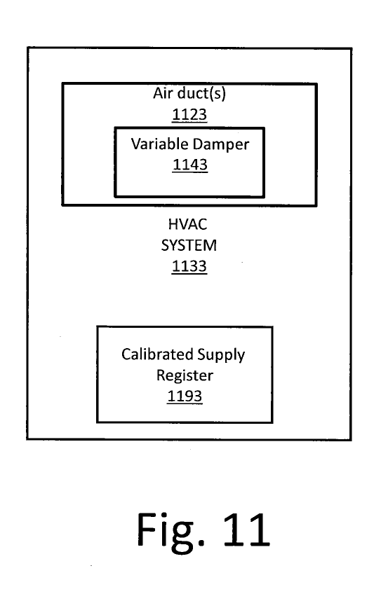

Referring now to FIG. 11, a block diagram of an HVAC system including a calibrated supply register in accordance with some embodiments of the present inventive concept will be discussed. It will be understood that the calibrated supply register as discussed herein may be used in any HVAC system including the systems illustrated in FIGS. 8 and 9 without departing from the scope of the present inventive concept. In some embodiments of the present inventive concept, this calibrated supply register 1193 may be implemented as the physical combination of a calibrated airflow manifold 890 that is attached externally downstream, and only temporarily, to a permanently installed supply register in order to achieve the same functionality as a calibrated supply register, as discussed with respect to embodiments of the present inventive concept.

As illustrated in FIG. 11, the HVAC system 1133 includes a calibrated supply register 1193 in accordance with embodiments of the present inventive concept. Most HVAC systems have some ducts attached to the supply manifold, often by using distribution boxes that allow several supply ducts to branch out from the supply manifold of the air handler in order to reach various rooms of the house. At the end of each of these supply ducts, regular HVAC system installations typically involve the installation of a supply register. Embodiments of the present inventive concept replace this supply register with a calibrated supply register configured to measure air flow, and then calibrate various sizes of supply registers (which fit various sizes of supply ducts) before shipping them to the house to be installed.

Communication between the calibrated supply registers 1193 and the central controller in the house discussed above may be by any means known to those having skill in the art. For example, communication may wired or wireless having a central power supply or by using local batteries. Air flow measurements at the calibrated supply registers do not have to be made all the time, but only at certain instances.

Thus, embodiments of the present inventive concept may directly measure the fraction of the total amount of air that is leaving the air handler which is being delivered to a certain supply register, and therefore the number of BTUs that are delivered to a specific room in the house.

In some embodiments, a variable (remotely controlled) damper 1143 may be installed in a supply duct 1123 serving one supply register. Multiple supply registers may be served, but each would have its own damper. In these embodiments, the airflow for each room can be adjusted on-the-fly as a function of the specific heating and cooling needs for that particular room, by time of day. Needs may change due to different solar gain, for example, different amounts of sunlight entering the room at various times of the day, drapes open or closed, because the occupants decide that they would like to have different amounts of heating or cooling supplied to this particular room at a particular point in time and the like. Thus, the amount of heating and/or cooling that is supplied to each room (frequently called “balancing the rooms in the house”) can be fine-tuned at the time of the installation of the HVAC system, and adjusted according to the projected heating and cooling loads that have been calculated as part of the HVAC system design process for this particular home.

Supply ducts are not always installed as intended, so they do not necessarily deliver the intended amount of air. Adjustable dampers provide remote control of each supply duct, thus, the allocation of hot or cold air does not have to remain static (or fixed) over time, it can follow any number of programmable profiles for each room of the house. When the fraction of the total air supplied by the air handler to a particular room is changed, all the other rooms of the house that are served by this HVAC system will detect a change. Since the air flow is being measured for all of the supply registers this data (observations) can be used to maintain an overall balance across all of the rooms that is acceptable to the occupants, by increasing or decreasing the total amount of air supplied by the air handler, which is measure by the current system all the time.

Performing these types of measurements separately for each type of home would make this process unaffordable. Using an adaptive reference model that is shared between all of the homes of a certain size and type, the cost of the associated analytics become extremely attractive. Thus, the shared adapative reference model discussed herein can be used to improve thermal comfort in every room of the house, to optimize energy consumption, throughout the day, and for various weather conditions (sun, no sun, more wind, etc.) and the like.

Embodiments of the present inventive concept make the process of simultaneously balancing the heating and/or cooling supplied to each room in the house possible and economically feasible. It constitutes an entirely new commissioning process, one that is currently not feasible because of the essentially endless iterations required if someone would attempt to do this “by hand”. Using cloud-based, and thus shared data analytics, and adaptive reference models that are specific for a particular type of home and climate zone, etc., this can now be done, for the first time ever.

Embodiments of the present inventive concept replace using hand-held air flow measurement devices, going from room to room, and adjusting manual dampers in the supply ducts in order to achieve approximately the air flow for each room (give or take) that was calculated during the HVAC system design process. Normal construction and HVAC system installation practices rely on the size of the supply ducts and registers that have been installed. No further adjustments take place, unless someone complains. If adjustments are made for a particular room, the amount of air supplied to all other rooms changes. Iterations can take an enormous amount of time.

Without the devices and systems discussed herein, manual air flow measurement devices would be used for each and everyone of the supply registers, concurrently. It would require a large number of air flow measurement devices, and also a large number of people to hold them up against all of the supply registers, all at the same time, to read the observed air flow for each of the devices, then process all of the observed air flows, and then decide on any changes that need to be made to the supply duct dampers.

As discussed briefly above, embodiments of the present inventive concept provide the ability to measure air flow (in the duct of an HVAC system) that is unevenly distributed in space and/or over time, and to measure it at a known level of accuracy and precision. Thus, a calibrated air flow measurement device (air flow grid) may be provided.

As further discussed above, use of an adaptive reference model (local reference model that is updated by a shared central database, for example, in the cloud) in a closed loop control system configuration may be used to improve the precision and accuracy of the air flow measurement process

Data analytics located, for example, in the cloud, using data from many observed instances may be shared to improve the accuracy and precision of each of the participating air flow measurement processes in order to lower the cost per system and per analytic procedure.

Some embodiments provided an ability to determine the heating and/or cooling capacity of the HVAC system under real-life operating conditions, i.e., while the HVAC system is operating, in addition to the determination of the system capacity in the course of a one-time installation or spot check procedure. The capacity of an HVAC system is defined as the HVAC system's ability to remove a specified amount of BTUs from the circulating air (in cooling mode), or to add a specified amount of BTUs (in heating mode). In order to determine the HVAC system capacity, the amount of air (air mass; the total number of air molecules) that is/are being conditioned (heated or cooled) for a specified unit of time (normally, an hour) is measured.

Some embodiments use the central, adaptive reference model to implement a closed loop control system that allows a specified HVAC system performance to be maintained over time, i.e., to maintain a specified performance level (specified as the ability to deliver a certain number of BTUs per unit of time). This generally requires the ability to detect any changes of the system capacity over time (deviations from a known level of performance), which leads directly to the requirement for a known level of precision and accuracy of the air flow measurement process.

As further discussed above, an EER of an HVAC system may be determined, close to real-time, continuously, under real-life operating procedures by using a shared (cloud-based), adaptive reference model to facilitate a closed loop control system. The EER is defined as the ratio of BTUs per kWh (electrical energy) that is consumed by the HVAC system in the process of delivering the desired number of BTUs per unit of time.

Some embodiments of the present inventive concept provide the ability to derive a model that accurately describes the performance of an HVAC system of a known brand and model, after it has been installed in a particular building or structure, and has been observed for an extended amount of time, under various external weather conditions, and various internal modes of operation (heating, ventilation and air conditioning). Use of such a model as the reference model in a closed loop control system, such as an model reference adaptive control (MRAC) system, for example, as well as one of the inputs for a shared reference model, as described in our original patent.

Some embodiments of the present inventive concept use a (calibrated) air flow measurement device to then calibrate the pressure differences that can be detected between various points in the path of the air as it flows through the air handler. The ability to do this ad hoc, and in situ, for each particular HVAC system installation is also discussed.

As discussed above, a duct manifold that incorporates a calibrated air flow measurement device (air flow grid) may be positioned temporarily in front of a return register, in lieu of an air flow grid that is installed in the duct in front of the air handler itself. Ability to repeat the air flow measurement process at any time to re-calibrate the detected pressure difference is also discussed.

Some embodiments use a duct manifold that incorporates a calibrated air flow measurement device (air flow grid) positioned temporarily in front of a supply register, or incorporated into a supply register in order to achieve an on-going thermal balance between the rooms in a home, under various external weather conditions, and various internal HVAC system operating modes. The adaptive reference model (local reference model that is updated by a central database, for example, in the cloud) may be used in a closed loop control system configuration in order to improve the precision and accuracy of the allocation to various rooms in the building at all times, under various external weather conditions, and various internal HVAC system operating modes.

Various embodiments were described herein with reference to the accompanying drawings, in which embodiments of the inventive concept are shown. This inventive concept may, however, be embodied in many different forms and should not be construed as limited to the embodiments set forth herein; rather, these embodiments are provided so that this disclosure will be thorough and complete, and will fully convey the scope of the inventive concept to those skilled in the art.

It will be understood that, when an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Furthermore, “coupled”, “connected”, “responsive”, or variants thereof as used herein may include wirelessly coupled, connected, or responsive. Like numbers refer to like elements throughout. The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. Well-known functions or constructions may not be described in detail for brevity and/or clarity.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present inventive concept. Moreover, as used herein, the term “and/or” includes any and all combinations of one or more of the associated listed items.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof Furthermore, if used herein, the common abbreviation “e.g.”, which derives from the Latin phrase exempli gratia, may be used to introduce or specify a general example or examples of a previously mentioned item, and is not intended to be limiting of such item. If used herein, the common abbreviation “i.e.”, which derives from the Latin phrase id est, may be used to specify a particular item from a more general recitation.

Exemplary embodiments were described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit such as a digital processor, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s). These computer program instructions may also be stored in a computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks.

Accordingly, embodiments of the present inventive concept may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments were disclosed herein, in connection with the description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed exemplary embodiments of the inventive concept. However, many variations and modifications can be made to these embodiments without substantially departing from the principles of the present inventive concept. Accordingly, although specific terms are used, they are used in a generic and descriptive sense only and not for purposes of limitation, the scope of the inventive concept being defined by the following claims.

That which is claimed is:

1. An airflow calibration system configured to be received in a duct of a heating, ventilating and air conditioning (HVAC) system, the air flow calibration system comprising:
a housing including an air flow grid; and
at least one pressure sensing cell positioned in the housing, the at least one cell being configured such that air flows through the at least one cell when the airflow calibration system is positioned in the duct of the HVAC system,
wherein the airflow calibration system is configured to be temporarily installed in the duct of the HVAC system to calibrate the HVAC system upon completion of the HVAC system or to recalibrate the HVAC system after a period of time.

2. The system of claim 1:
wherein the HVAC system includes an air handler, a return manifold and a media cabinet between the air handler and the return manifold;
wherein the HVAC system further includes an entry transition manifold between the filter media cabinet and the air handler and an exit transition manifold between the air handler and a supply manifold; and
wherein the at least one pressure sensing cell comprises a plurality of pressure sensing cells installed at least in both the entry and exit transition manifolds.

3. The system of claim 2, wherein the air flow grid is positioned in the filter media cabinet.

4. The system of claim 1:
wherein the HVAC system includes an air handler and a return manifold;
wherein the HVAC system further includes an entry transition manifold between the air handler and the return manifold and an exit transition manifold between the air handler and a supply manifold; and
wherein the at least one pressure sensing cell comprises a plurality of pressure sensing cells installed in at least both the entry and exit manifolds.

5. The system of claim 4, wherein the air flow grid is positioned in a return air stream in front of the return manifold.

6. The system of claim 1:
wherein the air flow grid of the airflow calibration system is coupled to an air handler module including a pressure difference unit and a data processing unit;
wherein the air flow grid is configured to measure a first airflow value corresponding a first speed for a fan in the air handler, the first speed being selected by the air handler module; and
wherein the original calibrated airflow value is compared to the measured first airflow value to provide a deviation between the original calibrated airflow value and the measured first airflow value.

7. The system of claim 6, wherein the airflow grid is configured to measure second through N airflow values and wherein second through N deviations are calculated for each of the corresponding airflow values.

8. The system of claim 6, wherein the airflow grid is removed after the system is calibrated and replaced by a filter for normal operations.

9. The system of claim 1, wherein the HVAC system includes a calibrated supply register configured to measure air flow in the HVAC system and determine a customized size for a supply register for the particular HVAC system.

10. The system of claim 9, wherein the HVAC system further includes at least one variable damper in a corresponding supply duct of the HVAC system configured to be controlled remotely to adjust airflow for each room associated with the at least one variable damper and the corresponding supply duct.

11. The system of claim 1, wherein the airflow calibration system communicates with a local reference model that is updated by a shared reference module located in a central database, the central database including information related to a plurality of HVAC systems remote from the HVAC system associated with the calibration system.

12. The system of claim 1, wherein the system is configured to measure an amount of air being conditioned for a specified unit of time.

13. A heating, ventilating and air conditioning (HVAC) system comprising:
an air flow calibration system, the airflow calibration system comprising:
a housing including an air flow grid; and
at least one pressure sensing cell positioned in the housing, the at least one cell being configured such that air flows through the at least one cell when the airflow calibration system is positioned in the duct of the HVAC system,
wherein the airflow calibration system is configured to be temporarily installed in the duct of the HVAC system to calibrate the HVAC system upon completion of the HVAC system or to recalibrate the HVAC system after a period of time.

14. The HVAC system of claim 13, further comprising:
an air handler, a return manifold and a media cabinet between the air handler and the return manifold;
an entry transition manifold between the filter media cabinet and the air handler; and
an exit transition manifold between the air handler and a supply manifold,
wherein the at least one pressure sensing cell comprises a plurality of pressure sensing cells installed at least in both the entry and exit transition manifolds.

15. The HVAC system of claim 14, wherein the air flow grid is positioned in the filter media cabinet.

16. The HVAC system of claim 13, further comprising:
an air handler and a return manifold; and
an entry transition manifold between the air handler and the return manifold; and
an exit transition manifold between the air handler and a supply manifold, wherein the at least one pressure sensing cell comprises a plurality of pressure sensing cells installed in at least both the entry and exit manifolds.

17. The HVAC system of claim 16, wherein the air flow grid is positioned in a return air stream in front of the return manifold.

18. The HVAC system of claim 13, further comprising:
an air handler module coupled to the air flow grid of the airflow calibration system, the air handler module including a pressure difference unit and a data processing unit,
wherein the air flow grid is configured to measure a first airflow value corresponding a first speed for a fan in the air handler, the first speed being selected by the air handler module; and
wherein the data processing unit compares the original calibrated airflow value is to the measured first airflow value to provide a deviation between the original calibrated airflow value and the measured first airflow value.

19. The HVAC system of claim 18, wherein the airflow grid is configured to measure second through N airflow values and wherein the data processing unit calculates second through N deviations for each of the corresponding airflow values.

20. The HVAC system of claim 18, wherein the airflow grid is removed from the HVAC system after the system is calibrated and replaced by a filter for normal operations.

21. The HVAC system of claim 13, further comprising a calibrated supply register configured to measure air flow in the HVAC system and determine a customized size for a supply register for the particular HVAC system.

22. The HVAC system of claim 21, further comprising at least one variable damper in a corresponding supply duct of the HVAC system configured to be controlled remotely to adjust airflow for each room associated with the at least one variable damper and the corresponding supply duct.

23. The HVAC system of claim 13, wherein the airflow calibration system communicates with a local reference model that is updated by a shared reference module located in a central database, the central database including information related to a plurality of HVAC systems remote from the HVAC system associated with the calibration system.

24. The HVAC system of claim 13, wherein the HVAC system is configured to measure an amount of air being conditioned for a specified unit of time.
